(19) United States
(12) Patent Application Publication
(10) Pub. No.: US 2009/0190726 A1
(43) Pub. Date: Jul. 30, 2009

(54) END-TO-END DEPLOYMENT VALIDATION OF COMMUNICATION SYSTEM

(75) Inventors: Wajih Yahyaoui, Bellevue, WA (US); Yiu-Ming Leung, Redmond, WA (US); Jeu George, Redmond, WA (US); Jisun Park, Issaquoh, WA (US); Rahul D. Indurkar, Bellevue, WA (US); Thomas J. Creath, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/020,749

(22) Filed: Jan. 28, 2008

(51) Int. Cl. H04M 1/24

(52) U.S. Cl. 379/15.01

(57) ABSTRACT

End-to-end testing of a communications network, specifically a unified communications network, is accomplished by employing one or more sets of agents controlled by one or more organizers. Agents, capable of initiating, emulating, and recording various aspects of communication, are deployed such that call can be made through a wide range of network paths. Test scenarios defined dynamically based on network conditions or based on administrator input are executed by an organizer, which directs the agents reporting to it. Collected results are analyzed for subsequent reporting and/or corrective actions. Alert criteria may also be defined causing an alert to be issued if a significant fault is discovered.

In telecommunication, telephony is the term for the general use of equipment to provide voice communication over distances, specifically by connecting telephones to each other. Telephones originally were connected directly together in pairs. In later systems, equipment at the exchange connects a telephone line to another in the same wire center, or to a trunk to a distant exchange when the user of a telephone wants to make a telephone call. The exchanges together form the Public Switched Telephone Network (PSTN).

As an alternative to PSTN systems, cellular phone networks have proliferated over the last decade where users with cellular phones have access to one or more networks at almost any location. Also a recent development is the wide spread use of Voice Over IP (VOIP) telephony, which uses internet protocol over wired and wireless networks.

With the availability of such diverse types of communication networks and devices capable of taking advantage of various features of these networks, a new technology is bringing different communication networks together providing until now unavailable functionality such as combining various modes of communication (e.g. instant messaging, voice calls, video communications, etc.). This technology is referred to as unified communications. A network of servers manages end devices capable of handling a wide range of functionality and communication while facilitating communications between the more modern unified communication network devices and other networks (e.g. PSTN, cellular, etc.).

Methods and systems to check operational status of main network components such as servers, exchanges, switches, etc., are known in the art. However, when a new network such as an enterprise unified communications network is deployed, a considerable amount of problems may occur at end device level. Typically, the administrators become aware of these problems when a user calls to report the problem. Similarly, when changes are made to the network configuration (new equipment added, software upgraded, etc.) effects on end devices may not be detected immediately causing a degradation of user experience.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to enabling end-to-end testing of a network, specifically a unified communications network employing a set of agents controlled by an organizer. According to some embodiments, Agents, capable of initiating, emulating, and recording various aspects of communication, are deployed at predefined locations. Test scenarios are defined dynamically based on network conditions or administrator input by an organizer, which directs the agents to perform the test scenario(s). Results are collected and analyzed for subsequent reporting and/or corrective actions.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a diagram illustrating an example unified communications system;

FIG. 2 illustrates a unified communications system with agents deployed at various subnets for testing end-to-end communication scenarios;

FIG. 3 is a conceptual diagram, illustrating main components of an end-to-end testing system using agents and an organizer according to embodiments;

FIG. 4 illustrates another system according to embodiments, where multiple organizers with their own agents may be deployed validating end-to-end performance of a unified communications network;

FIG. 5 illustrates two example test scenarios for an example system employing four agents;

FIG. 6 illustrates a networked environment where embodiments may be implemented;

FIG. 7 is a block diagram of an example computing operating environment, where embodiments may be implemented; and

FIG. 8 illustrates a logic flow diagram for a process of employing agents to validate end-to-end performance in a unified communication system according to embodiments.

### DETAILED DESCRIPTION

As briefly discussed above, a set of agents controlled by an organizer may be utilized to test end-to-end performance of a unified communications network. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

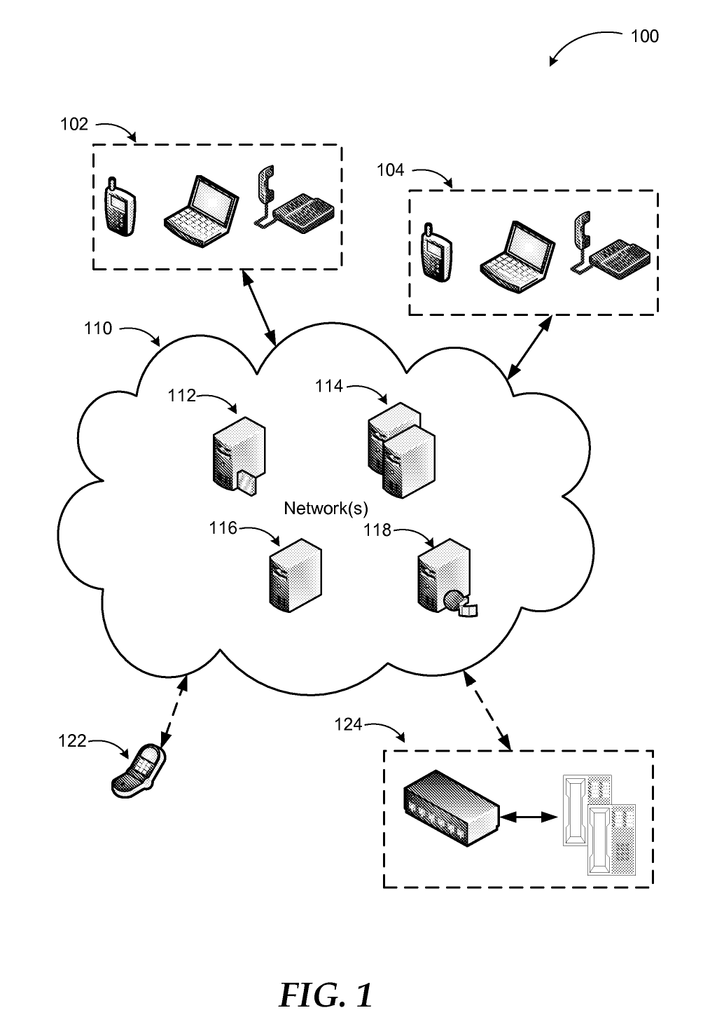

Referring to FIG. 1, diagram 100 of an example unified communications system is illustrated. As mentioned above, existing validation methods for communication networks typically test main components such as servers by pinging them, testing throughput between servers, and the like. However, physical and software aspects of the connection beyond the server(s) can attribute to significant degradation of communication quality or even lack of connection.

In a unified communication system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (PSTN). End devices may include any type of smart phone, cellular phone, any computing device executing a communication application, a smart automobile console, and advanced phone devices with additional functionality.

Unified Communication (UC) Network(s) 110 includes a number of servers performing different tasks. For example, UC servers 114 provide registration, presence, and routing functionalities. Presence functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent (e.g. Business-To-Business User Agent “B2BUA”).

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a preferred method.

The SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients use Transport Control Protocol (“TCP”) or User Datagram Protocol (“UDP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

SIP is intended to provide a signaling and call setup protocol for IP-based communications that can support a superset of the call processing functions and features present in the PSTN. SIP by itself does not define these features, however. Rather, its focus is call-setup and signaling. SIP is also designed to enable the building of such features in network elements known as proxy servers and user agents. These are features that permit familiar telephone-like operations: dialing a number, causing a phone to ring, hearing ring back tones or a busy signal.

SIP-enabled telephony networks can also implement many of the more advanced call processing features. SIP is a client/server protocol that enables peer-to-peer connectivity because each side can function as a client and a server at the same time. As such it requires a relatively simple core network with intelligence distributed to the network edge, embedded in endpoints (end devices built in either hardware or software). SIP features are implemented in the communicating endpoints (i.e. at the edge of the network) as opposed to being implemented in the network.

As discussed below in more detail, organizer(s) and agents deployed in a communication system for end-to-end validation of connectivity and quality may communicate among each other employing SIP. While the example systems are described with SIP features in following figures, many other Voice over IP (VoIP) protocols exist and embodiments may be implemented with any of those protocols using the principles described herein.

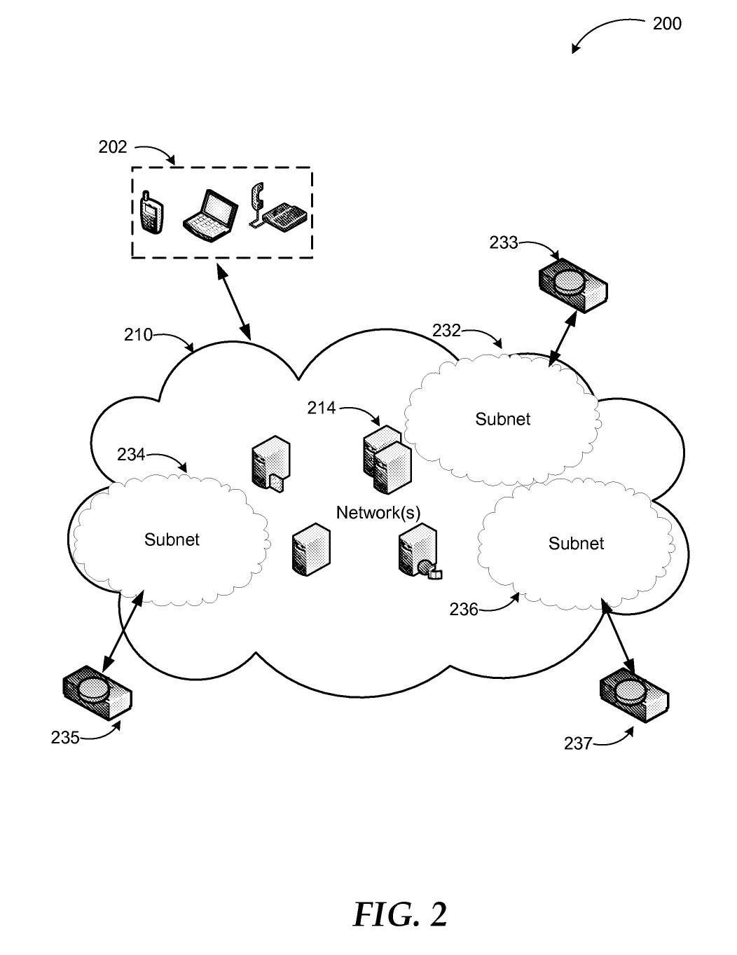

FIG. 2 illustrates a unified communications system with agents deployed at various subnets for testing end-to-end communication scenarios. Network 210 in diagram 200 is a UCN as discussed above. Network 210 may include a number of subnets such as subnets 232, 234, and 236. Network 210 may include one or more of the servers discussed above such as UC servers 214 and facilitate communication for client devices 202.

Agents 233, 235, and 237 are combinations of hardware and software capable of placing calls to each other to verify connectivity of the target communication system (in this case network 210). In addition to voice calls, agents may also be configured to test various aspects of the communication network such as quality of communication. For example, agents may test for packet loss, jitter, delay, and other pre-defined parameters during end-to-end calls. Moreover, the agents may test any communication mode such as instant messaging, video communication, application sharing, data sharing, and the like. After initiating communication, each agent generates traffic emulating a real end user.

Agents 233, 235, and 237 may be deployed at strategic locations on the network 210 such as one agent per subnet (to avoid duplicate testing and maximize number and variety of tested pathways). In addition to different subnets, agents may also be place according to other aspects such as inside or outside of a firewall, a wired or wireless network (sub-network), and the like. While agents 233, 235, and 237 are shown as identical agents, different types of agent may also be utilized. For example, some agents may be specialized for testing particular modes of communication. Moreover, different types of agents for testing communication with other types of networks may also be utilized. For example, an agent for testing the UCN only may be capable of placing VOIP calls while a PSTN agent acting like an answering machine to answer PSTN phone calls and/or an autodialing machine to place PSTN phone calls to the UCN may be used in conjunction with a PSTN component of the system. For cellular networks, a similarly configured cellular agent capable of emulating a cellular phone may be employed.

While the example systems in FIG. 1 and 2 have been described with specific components such as mediation server, A/V server, and the like, embodiments are not limited to these components or system configurations and can be implemented with other system configuration employing fewer or additional components. Functionality of the systems enabling end-to-end testing through agents may also be distributed among the components of the systems differently depending on component capabilities and system configurations.

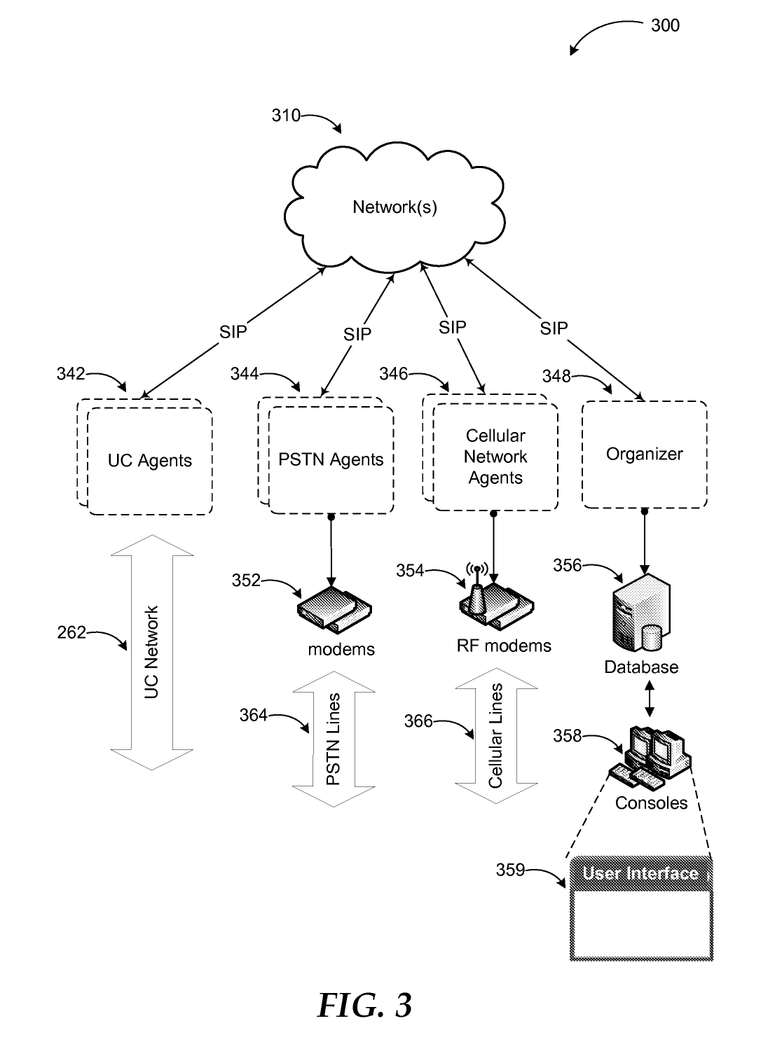

FIG. 3 is a conceptual diagram, illustrating main components of an end-to-end testing system using agents and an organizer according to embodiments. Networks 310 in diagram 300 represent a multi-component communication system with UCN, cellular, and PSTN components. End devices for each of the components are not shown in this diagram for simplicity.

Agents for various components of the system such as UC agents 342, PSTN agents 344, and cellular network agents 346 communicate with organizer 348 using SIP or another protocol. Organizer 348 is the central commander which orchestrates all testing and validation activities in the system through the agents. The agents in turn test their respective network components such as UC network 262, PSTN lines 364, or cellular lines 366. The latter two agents may utilize PSTN modems 352 or RF modems 364 for communication through the respective networks.

Organizer 348 is responsible for the functions such as maintaining a list of available agents, scheduling test cases to be executed, sending instructions to the agents involved for each test case to be executed, receiving results from the agents after a test case has been executed, aggregating the results and determining the success/failure status of each particular test case, generating alerts if a test case fails, and receiving commands from the administrator through console(s) 358 (and user interface 359) and performing them accordingly.

Consoles 358 may be used by the administrator for obtaining a status of how the system is running, changing various operating parameters, executing test cases manually, and managing the list of agents. The administrator may also define or modify alert conditions, alert thresholds, and other parameters associated with testing end-to-end communications. Database 356 may be used to store test configurations, agent information, and test results, as well as reports based on analysis of test results.

In an example operation according to embodiments, organizer 348 creates a number of test cases, called a test suite (e.g. during the initial setup time). Each test case represents a “test” that can be performed on the target system and involves a set of agents. Organizer 348 may launch these test cases periodically or as defined by the administrator. Test cases may also be launched in response to changes in the system such as deployment of new hardware or software. Test cases may also be launched manually by the administrator through the console.

When a test case is launched, organizer 348 prepares commands for each agent involved and transmits the commands to the agents accordingly. When the test is completed, the agents send the results back to the organizer. According to one embodiment, a time out mechanism may be built into the system in case a message is lost or one or more agents become unresponsive.

A test case may be considered to fail by two categories: connectivity or quality as evaluated by the organizer. Connectivity failure may occur if one or more agents cannot connect, one or more agents fail to receive a connect signal, or one or more agents has less than half of the expected packets exchanged. Quality failure may occur if network jitter is more than a preset time threshold, network packet loss is more than a preset percentage, burst length is greater than a preset time threshold, or degradation to another quality parameter exceeds a preset threshold. Of course other failure criteria may also be defined, as well as the preset thresholds may be dynamically modified. An alert may be generated if a test case fails in either of these categories.

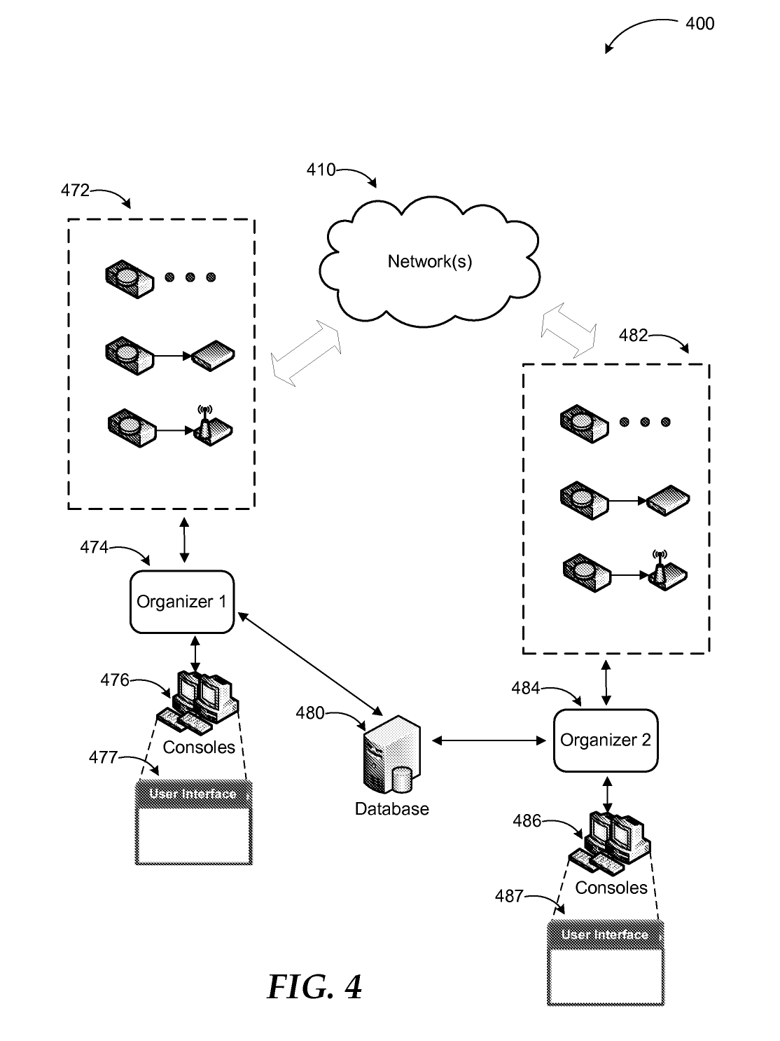

FIG. 4 illustrates another system according to embodiments, where multiple organizers with their own agents may be deployed validating end-to-end performance of a unified communications network.

Diagram 400 illustrates scalability of an end-to-end test and validation system employing agents. Different sets of agents may be assigned to a number of organizers (e.g. agents 472 to organizer 474, agents 482 to organizer 484, and the like). Each organizer may have its own console(s) (476, 486) and user interfaces (477, 487). The organizers may work with the same database 380 or have a database of their own. According to another embodiment, a “super” organizer may coordinate the actions of the distinct organizers. The groups of agents assigned to each organizer may vary in their numbers, types, or locations (e.g. geographic, network location, etc.).

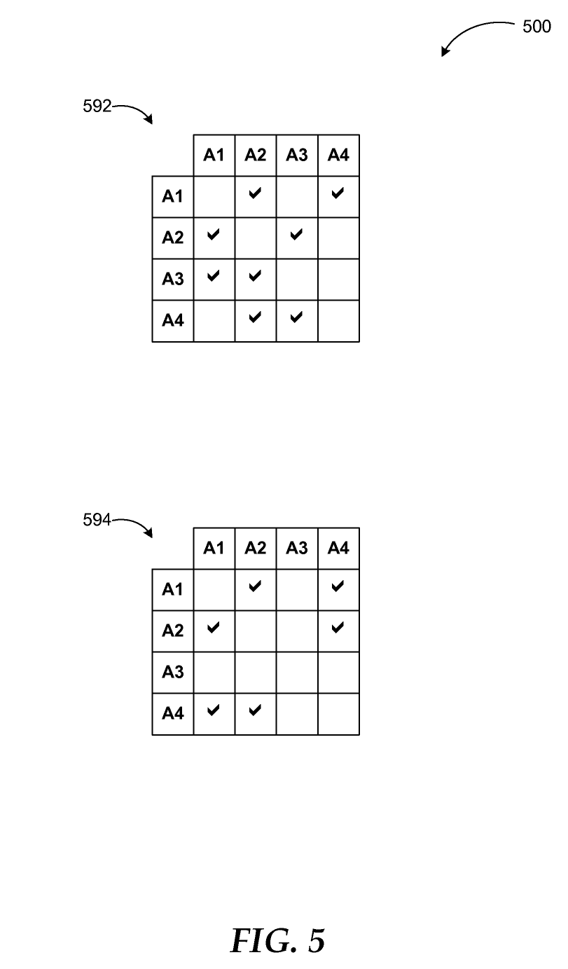

FIG. 5 illustrates two example test scenarios for an example system employing four agents. As discussed previously, a wide spectrum of end-to-end communication properties of a network may be tested by agents depending on their number, configuration, specialization, and the like.

According to first test scenario 592, end-to-end call qualities are tested between four different agents (A1 through A4). The agents may be deployed at different locations (e.g. subnets) to test as many pathways as possible. A number of servers and other components (e.g. repeaters) between the agents' locations may determine how the test scenario is set up. In the example scenario, agent A1 is configured to place a call to agents A2 and A4; agent A2 is configured to call agents A1 and A3; agent A3 is configured to call A1 and A2; and agent A4 is configured to call agent A2 and A3. While repeat calls may be avoided, in some cases two agents may be configured to call each other since the calls may go through different paths.

Test scenario 594 is for testing a video conference system. The test scenario calls for a video conference to be established between agents A1, A2, and A4. While the test scenario is represented as a table, it may be generated and stored in linear or multi-dimensional format. For example, a multi-dimensional matrix may be associated with a test suite comprising multiple tests for a conference system where each combination of two dimensions may define one test between selected agents.

The operations and scenarios, as well as components of a unified communication system tested employing agents, described in FIG. 2-5 are exemplary for illustration purposes. A unified communication system validated end-to-end employing agents may be implemented using additional or fewer components and other schemes using the principles described herein.

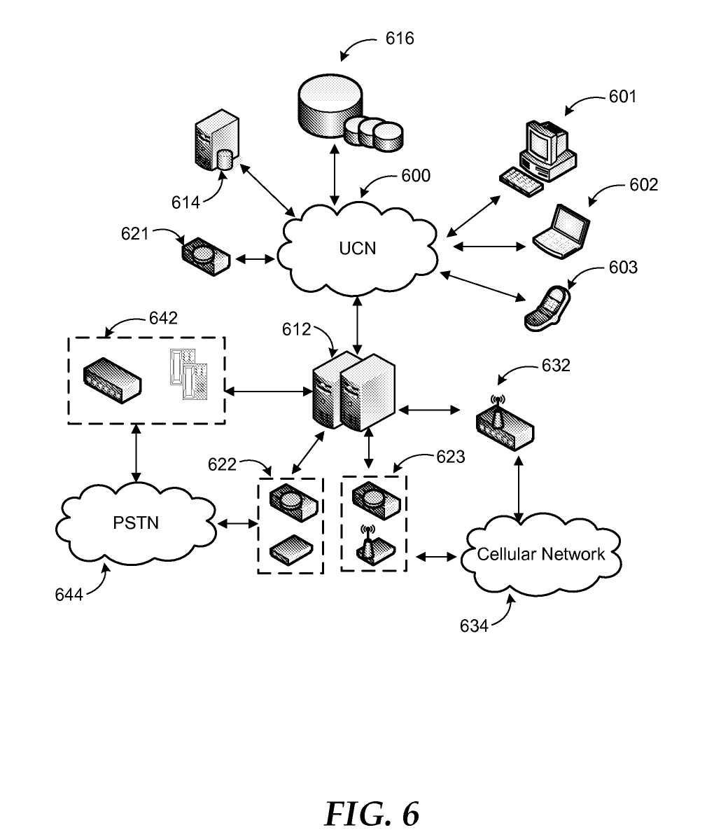

FIG. 6 is an example networked environment, where embodiments may be implemented. End-to-end deployment validation of communication systems as described previously may be implemented locally or in a distributed manner over a number of physical and virtual clients and servers. Such a system may typically involve one or more networks such as PSTN 644, cellular network 634, and UCN 600. At least one of the systems may be implemented in un-clustered systems or clustered systems employing a number of nodes communicating over one or more networks.

A system according to embodiments may comprise any topology of servers, clients, Internet service providers, and communication media. Also, the system may have a static or dynamic topology. The term “client” may refer to a client application or a client device. A system according to embodiments may involve many more components, typical and relevant ones are discussed in conjunction with this figure.

Mediation server(s) 612 may provide signaling and media exchange between the two systems. A PBX 642 and an RF modem 632 may be used for connection between the PSTN and the cellular networks, respectively, and the mediation server(s) 612. Client devices 601-603 communicate with each other and with devices on other networks through UCN 600. The UC system may also include a UC server (not shown) for registering, routing, and other functionality.

End-to-end testing of the networks may be performed by agents deployed at various locations on the UCN 600 (e.g. agent 621) and/or agents deployed on other networks (agents 622 and 623). The agents may be controlled by one or more organizers executed on a dedicated server, the mediation server 612, or the UC server. Data associated with the system configuration (e.g. user names, phone numbers, call policies, configuration, records, etc.), test configurations, test results, and so on, may be stored in one or more data stores such as data stores 616, which may be directly accessed by the servers and/or clients of the system or managed through a database server 614. UCN 600 provides the backbone of the UC system and may employ a number of protocols such as SIP, RTP, and the like. Client devices (e.g. 601-603) provide platforms for UCN user end points. Users may access the communication system using a client device or one or more client applications running on a client device.

UCN 600 provides communication between the nodes described herein. By way of example, and not limitation, UCN 600 may include wired media such as a wired network or direct-wired connection, and wireless media such as acoustic, RF, infrared and other wireless media.

Many other configurations of computing devices, applications, data sources, data distribution systems may be employed to implement end-to-end testing of a communication system. Furthermore, the networked environments discussed in FIG. 6 are for illustration purposes only. Embodiments are not limited to the example applications, modules, or processes.

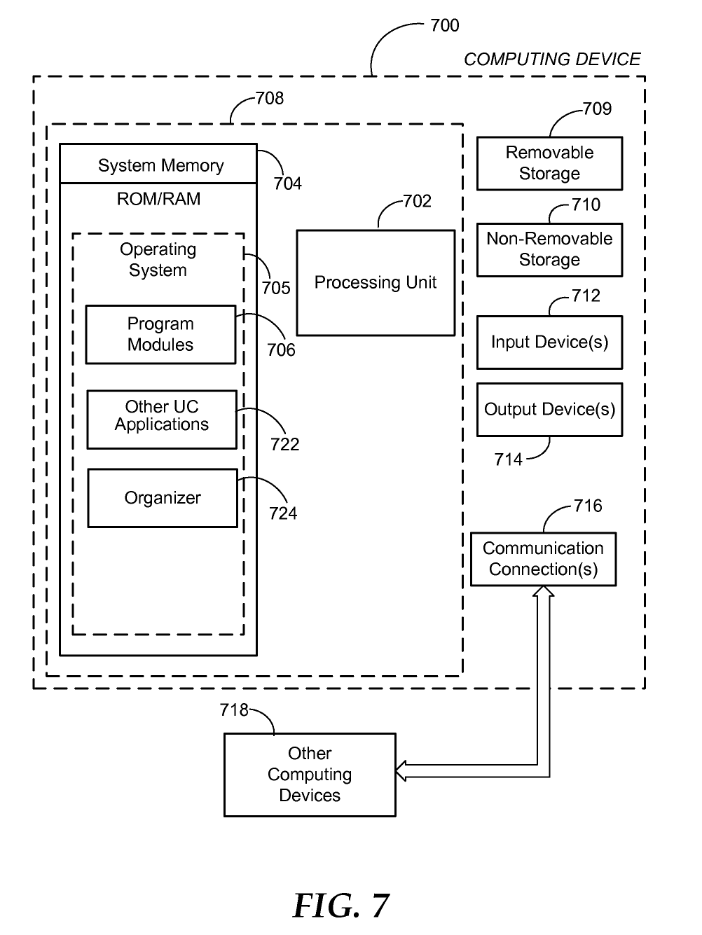

FIG. 7 and the associated discussion are intended to provide a brief, general description of a suitable computing environment in which embodiments may be implemented. With reference to FIG. 7, a block diagram of an example computing operating environment is illustrated, such as computing device 700. In a basic configuration, the computing device 700 may be a server executing an organizer application for controlling test agents in a unified communication system. Computing device 700 may typically include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the computing device, such as the WINDOWS® operating systems from MICROSOFT CORPORATION of Redmond, Wash. The system memory 704 may also include one or more software applications such as program modules 706, other UC applications 722, and organizer 724.

Other UC applications 722 may be separate applications or integral modules of a hosted service application that provide advanced communication services through computing device 700 such signal routing, registration, and communication facilitation services with the end devices of the UC system, as described previously. Organizer 724 configures test scenarios for deployed agents, directs the agents to perform testing, collects and reports the results. Organizer 724 may also issue alerts if a predefined fault criterion is reached. This basic configuration is illustrated in FIG. 7 by those components within dashed line 708.

The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of device 700. Computing device 700 may also have input device(s) 712 such as keyboard, mouse, pen, voice input device, touch input device, etc. Output device(s) 714 such as a display, speakers, printer, etc. may also be included. These devices are well known in the art and need not be discussed at length here.

The computing device 700 may also contain communication connections 716 that allow the device to communicate with other computing devices 718, such as over a wireless network in a distributed computing environment, for example, an intranet or the Internet. Other computing devices 718 may include client devices of a UC network or agents as discussed above. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

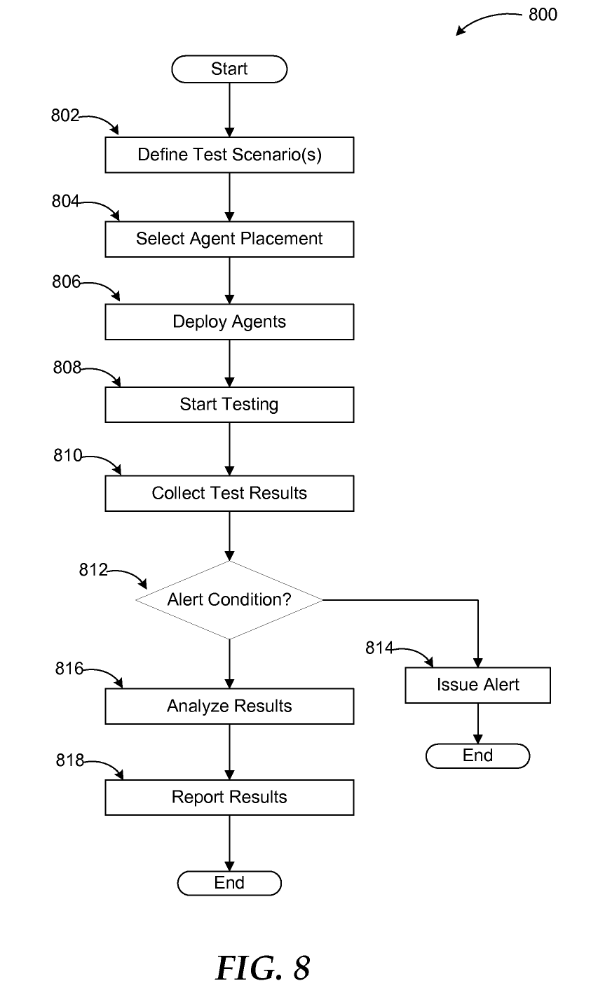

FIG. 8 illustrates a logic flow diagram for process 800 of employing agents to validate end-to-end performance in a unified communication system according to embodiments.

Process 800 begins with operation 802, where one or more test scenarios are defined. The test scenarios may be predefined by an administrator or dynamically generated based on predefined rules and changes to the network. For example, the organizer may dynamically generate new test scenarios upon receiving information about a network change such as the addition of new end devices or a subnet. According to other embodiments, the test scenarios may be defined after the deployment of the agents. Processing advances from operation 802 to operation 804.

At operation 804, agent placement locations are selected. Agents may be placed at locations where it would make most sense for testing end-to-end performance of the network such as different subnets, inside or outside of a firewall, and the like. Processing continues to operation 806 from operation 804, where the agents are deployed. As discussed previously, agents are a combination of hardware and software emulating end devices and initiating communications.

At operation 808 following operation 806, testing is initiated according to a selected test scenario with calls (voice calls, instant messages, video communications, application sharing, and the like) being placed from selected agents to other agents. Processing advances to operation 810 from operation 808.

At operation 810, test results are collected by the organizer from the agents participating in the test. Processing then continues to decision operation 812, where a determination is made whether an alert condition is detected. Alert conditions may be predefined according to default criteria or administrator defined criteria. If an alert condition is detected, the alert is issued at operation 814. The alert may be issued in form of an email, a voice call, an instant message, and the like. The alert may also be in form of an audio and/or visual indication on an organizer user interface (console). If no alert condition is detected, processing moves to operation 816.

At operation 816, the results are analyzed. The analysis may be performed by the organizer and a report provided at following operation 818. Alternatively, the organizer may store the results at a predefined location (data store), where the results can be accessed by one or more analysis applications and analyzed.

The operations included in process 800 are for illustration purposes. End-to-end testing of communication systems may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for validating end-to-end communication in a unified communication network (UCN), the method comprising:
defining a test scenario for validating the end-to-end communication;
deploying a plurality of agents at strategic locations within the UCN;
enabling the agents to execute the test scenario comprising at least one test;
collecting data associated with test results from the agents;
if an alert condition due to failure is satisfied, issuing an alert;
analyzing the collected data; and
providing a report based on the analyzed data.

2. The method of claim 1, wherein the agents are configured to execute the test scenario and provide data associated with the test results automatically.

3. The method of claim 1, further comprising:
employing an organizer to perform tasks including at least one from a set of:
maintaining a list of available agents;
scheduling test cases to be executed;
transmitting instructions to the agents for each test case to be executed;
receiving results from the agents after a test case has been executed;
aggregating the results;
determining one of a success and a failure status for each executed test case; and
generating alerts if a specific test case status is determined to be failure.

4. The method of claim 3, wherein a failure status is determined based on one of: a connectivity failure and a quality failure.

5. The method of claim 4, wherein the connectivity failure is deemed to occur if one from a set of: at least one agent's inability to connect, at least one agent's inability to receive a connect signal, and at least one agent's inability to receive more than a predetermined number of expected packets exchanged, is detected.

6. The method of claim 4, wherein the quality failure is deemed to occur if one from a set of: network jitter being more than a preset time threshold, network packet loss being more than a preset percentage, and burst length being greater than a preset time threshold, is detected.

7. The method of claim 1, wherein deploying the agents at strategic locations includes placing agents based on at least one from a set of: a number of subnets within the UCN, a number of external networks associated with the UCN, a location of a firewall within the network, and a type of different sub-networks within the UCN.

8. The method of claim 7, wherein the external networks associated with the UCN are at least one of a cellular network and a Public Switched Telephone Network (PSTN), and wherein a cellular agent and a PSTN agent are used for the respective external networks.

9. The method of claim 8, wherein the cellular and the PSTN agents employ a cellular and a PSTN modem, respectively, and wherein each agent is capable of receiving a call, recording a call, and initiating a call over the cellular and PSTN networks, respectively.

10. The method of claim 3, wherein the alert is issued as at least of one from a set of: a pre-recorded voice call to an administrator, an email to an administrator, an instant message to an administrator, an audio indication through a user interface associated with the organizer, and a visual indication through the user interface associated with the organizer.

11. The method of claim 1, wherein at least a portion of the agents are specialized for testing a particular aspect of the UCN.

12. A system for validating end-to-end communication in a unified communication network (UCN), the system comprising:
an organizer application executed on at least one server of the UCN, configured to:
maintain a list of available agents deployed at strategic locations within the UCN and any external networks associated with the UCN;
schedule test cases for validating end-to-end communication to be executed;
transmit instructions to the agents involved for each test case to be executed;
receive results from the agents after a test case has been executed;
aggregate the results;
determine one of a success and a failure status for each executed test case; and
if an alert condition based on a failure status associated with a specific test case met, issue an alert to an administrator; and
a plurality of agents, configured to:
execute test cases in response to receiving the instructions from the organizer application by:
initiating a communication that includes at least one from a set of: a voice call, an instant message, a video call, a conference call, an application sharing session, and a data sharing session;
generating network traffic by facilitating the initiated communication;
recording test parameters associated with the facilitated communication; and
reporting the recorded test parameters to the organizer application.

13. The system of claim 12, wherein the organizer application is associated with at least one console user interface configured to:
provide a status of test cases being executed;
enable an administrator to at least one of: define and modify test case parameters;
enable the administrator to manage the plurality of agents; and
enable the administrator to at least one of: define and modify alert conditions.

14. The system of claim 12, wherein the organizer application is further configured to schedule test cases to be executed based on one of: expiration of a predefined period, a hardware modification within the UCN, and a software modification within the UCN.

15. The system of claim 12, wherein the organizer application is further configured to dynamically modify at least one of: a test case, the schedule of a test case, and an alert condition in response to a modification within the UCN.

16. The system of claim 12, further comprising:
a second organizer application for managing a second plurality of agents; and
the second plurality of agents, wherein the plurality of agents and the second plurality of agents are configured to test distinct aspects of the UCN.

17. The system of claim 16, wherein the distinct aspects of the UCN include at least one from a set of: a geographic location, a virtual location, a physical characteristic, a software characteristic, and a number and type of external networks associated with the UCN.

18. A computer-readable storage medium with instructions stored thereon for validating end-to-end communication in a unified communication network (UCN), the instructions comprising:
deploying a plurality of groups of agents at strategic locations within the UCN and external networks associated with the UCN, wherein each group of agents is managed by an organizer and each group of agents is configured to test a different aspect of the UCN;
defining a test suite of at least one test case for validating the end-to-end communication;
scheduling the at least one test case based on one of a predefined period and a change to the UCN;
instructing the agents to execute the at least one test case based on the schedule;
collecting data associated with test results from the agents;
analyzing the collected data;
if an alert condition due to one of a connectivity failure and a quality failure is satisfied, issuing an alert; and
providing a report based on the analyzed data.

19. The computer-readable storage medium of claim 18, wherein organizers managing different groups of agents are configured to store at least one of agent configuration data and test result data in a common database.

20. The computer-readable storage medium of claim 18, wherein the instructions further comprise:
enabling a “super” organizer to manage the organizers managing different groups of agents, wherein each group of agents differ from another group with regard to one of: agent type, geographic agent location, virtual agent location, and a number of agents;
enabling an administrator to manage at least one from a set of: a schedule of test cases, a configuration of test cases, a configuration of agents, and a configuration of collected data analysis through a console associated with the “super” organizer.
